(19) United States
(12) Patent Application Publication
(10) Pub. No.: US 2026/0351976 A1
(43) Pub. Date: Nov. 5, 2026

(54) ENERGY STORAGE SYSTEM WITH VOLTAGE DERIVATIVE RESPONSE-BASED CONTROL

(71) Applicant: Fluence Energy, LLC, Arlington, VA (US)

(72) Inventor: Benjamin Joseph Braun, Berlin (DE)

(73) Assignee: Fluence Energy, LLC, Arlington, VA (US)

(21) Appl. No.: 19/538,871

(22) Filed: Feb. 12, 2026

Related U.S. Application Data
(60) Provisional application No. 63/767,789, filed on Mar. 6, 2025.

(51) Int. Cl. H02J 3/32; H02J 3/001; H02J 9/06

(52) U.S. Cl. CPC H02J 3/32; H02J 3/001; H02J 9/06

(57) ABSTRACT

A method for controlling an energy storage system (ESS) includes determining a voltage strength level of a power grid as a maximum power surge that would not cause the ESS to exceed defined voltage limits. The method includes determining a baseline system voltage strength level required by the grid during steady-state operation thereof, and controlling an output state of the ESS to collectively meet the baseline. The method further includes sensing corresponding voltages for respective battery elements and detecting a grid event, including obtaining a rate of change of voltage (RoCoV) of the grid. In response to the grid event, the method includes temporarily adjusting the baseline system voltage strength level via control of the ESS when one or more of the corresponding voltages reaches the defined voltage limits. The ESS may include battery elements, sensors, and an electronic control unit configured to perform the method.

### CROSS-REFERENCE TO RELATED APPLICATIONS

The present application claims the benefit of priority to U.S. Provisional Application No. 63/767,789 filed on Mar. 6, 2025, which is hereby incorporated by reference in its entirety.

### INTRODUCTION

The concepts described herein relate to the control of electric energy storage systems used as uninterruptible power supplies for a power grid, e.g., an alternating current (AC) power station. An energy storage system can be constructed from series-connected and/or parallel-connected energy storage modules or “cores”. Each energy storage module contains an application-suitable number of energy storage devices, for instance rechargeable electrochemical battery cells. Each energy storage module is securely contained within one or more enclosures. In a typical application in which the energy storage device is a battery, the battery's constituent battery cells may be recharged when a state of charge (SoC) of the battery or its constituent battery cells drops below a predetermined low SoC threshold. The ESS selectively discharges stored electrical power from the battery cells back to the power grid during periods of increased energy demand.

The ongoing shift to renewable energy sources has left utility power grids with reduced voltage strength and reduced power stability. As used herein and in the art, “voltage strength” refers to an immediate power response by a grid-following device to a grid-side power surge (or power drop). Voltage strength in turn is based on the “stiffness” of voltage sources connected to the electrical grid. From the perspective of energy consumers, therefore, the ability of an energy supplier to quickly respond to grid disturbances is essential for maintaining power quality and overall system stability.

### SUMMARY

Disclosed herein are circuit topologies and related methods for optimizing the performance of an energy storage system (ESS) of the type noted above, e.g., an uninterruptible power supply (UPS) for use with alternating current (AC) grid power. Disclosed embodiments relate to the control of output power of the ESS when coupled to an AC power grid. As described in detail hereinbelow, power control is established and maintained based on a measured (or calculated) rate of change of voltage (“RoCoV”) of the AC power grid.

The hardware-based and software-based solutions presented herein are intended to expedite the ESS's reactive support to grid disturbances (“grid events”). Improved reactive support is achieved at least in part by allowing the ESS to react to the RoCoV rather than, e.g., an absolute voltage deviation from a calibrated threshold level. The calculated rate, RoCoV, is thus used as a real-time control parameter when regulating operation of the ESS and its component energy storage modules, devices, and unit cells.

In particular, a method for controlling an ESS connected to an external power source, e.g., an AC power grid, includes directly or indirectly sensing a corresponding voltage for each respective energy storage device in the ESS. Representative energy storage devices may include battery modules or battery cells, without limitation. Using a model of the ESS, the method may include determining a voltage strength or maximum power surge of the external power source that would not cause the ESS to exceed defined voltage trip limits, i.e., calibrated (predetermined) maximum and minimum voltages of the ESS. The derived voltage strength may be represented in some embodiments as a voltage stiffness, e.g., kilovolt-ampere reactive (kVAR)/RoCoV, where the kVAR term represents the reactive power and RoCoV, as noted above, is the rate of change of voltage supplied by the external power source. The RoCoV value may be communicated to respective plant controllers and/or control processors of the ESS, for instance dedicated control processors for a plurality of energy storage units of the ESS.

During ESS operation, each energy storage unit is individually controlled such that the energy storage units collectively provide the above-noted voltage stiffness and thus meet the voltage strength needed by the external power source. When the energy storage units reach their calibrated maximum or minimum voltages, however, the method includes curtailing the voltage strength dispatched to the various energy storage units. This commanded control action reduces the ESS's voltage strength, e.g., for a sensed transient positive RoCoV event occurring at a threshold high SoC.

The threshold high SoC may be defined by converter capabilities of the ESS based on hardware limitations and current voltage levels (alternating current and direct current), or a transient negative RoCoV event occurring at a threshold low SoC that is likewise defined by converter capabilities based on hardware and current AC and DC voltage levels, while respecting short term power ratings of upstream equipment at all times.

In accordance with an aspect of the disclosure, a method for controlling an ESS having a plurality of battery elements includes determining a voltage strength level of a power grid, with the voltage strength level being a maximum power surge of the power grid that would not cause the ESS to exceed defined voltage limits. The method includes determining a baseline system voltage strength level required by the power grid during steady-state operation thereof, and then controlling an output state of the ESS to collectively meet the baseline system voltage strength level. Additionally, the method includes sensing corresponding voltages for each respective one of the battery elements, as well as detecting a grid event of the power grid, including obtaining a RoCoV value of the power grid. In response to the grid event, the method includes temporarily adjusting the baseline system voltage strength level using the RoCoV, via control of the battery elements, when one or more of the corresponding voltages reaches the defined voltage limits.

In various implementations, detecting the grid event includes sensing a RoCoV event of the power grid during a threshold high SoC of the ESS or a threshold low SoC of the ESS.

The method may include determining a relationship between the RoCoV and an amount of change of output power for the ESS, and then calculating an amount of change of the output power for the ESS. The latter occurs based on the relationship and the RoCoV. Calculating the amount of change of the output power for the ESS may include combining a reference output power and the calculated amount of change. Temporarily adjusting the baseline system voltage strength level may optionally include transmitting control signals to one or more local control processors of the ESS to thereby command the change in output power.

Determining the voltage strength level of the power grid may include receiving voltage measurements from one or more sensors, and then calculating the voltage strength level using the voltage measurements. Temporarily adjusting the baseline system voltage strength level may optionally include increasing reactive power within the ESS.

Also disclosed herein is an ESS for use with a power grid. An example construction of the ESS may include a plurality of battery elements, one or more sensors, and an electronic control unit (ECU) in communication with the one or more sensors. The ECU is configured to determine voltage strength level of the power grid, the voltage strength level being a maximum power surge of the power grid that would not cause the ESS to exceed defined voltage limits. The ECU is also configured to determine a baseline system voltage strength level required by the power grid during steady-state operation thereof, and to control an output state of the battery elements to collectively meet the baseline system voltage strength level.

Additionally, the ECU determines corresponding voltages for each respective one of the battery elements, e.g., electrochemical battery cells, detects a grid event of the power grid, including obtaining a RoCoV of the power grid, and in response to the grid event, temporarily adjusts the baseline system voltage strength level via control of the battery elements when one or more of the corresponding voltages reaches the defined voltage limits.

The sensors may include at least one voltage sensor operable for directly sensing the corresponding voltages as corresponding cell voltages of the electrochemical battery cells. The ECU may be configured to determine the grid event as a RoCoV of the power grid during a threshold high SoC of the ESS or a threshold low SoC of the ESS.

The ECU may also be configured to determine a relationship between the voltage strength level and an amount of change of output power for the ESS, and to calculate, based on the relationship and the voltage strength level, an amount of change of the output power for the ESS.

In some implementations, the ESS is configured to calculate the amount of change of the output power for the ESS by combining a reference output power and the calculated amount of change of the output power for the ESS. The ECU may also temporarily adjust the baseline system voltage strength level by transmitting control signals to one or more control processors of the ESS to thereby command the amount of change of the output power for the ESS.

Embodiments of the ECU are configured to obtain the voltage strength level of the power grid by receiving voltage measurements from one or more sensors and calculating the voltage strength level using the voltage measurements. The ECU may temporarily adjust the baseline system voltage strength level by increasing reactive power within the ESS.

In yet another disclosed embodiment, an ECU for an ESS for use with a power grid includes a processor and a computer storage medium (“memory”) on which is recorded instructions. The instructions are executable by the processor to cause the ECU to determine a voltage strength level of a power grid, the voltage strength level being a maximum power surge of the power grid that would not cause the ESS to exceed defined voltage limits, and to determine a baseline system voltage strength level required by the power grid during steady-state operation thereof. Instruction execution also causes the ECU to control an output state of a plurality of battery elements of the ESS to collectively meet the baseline system voltage strength level, sense corresponding voltages for each respective one of the battery elements, and detect a grid event of the power grid, including obtaining RoCoV of the power grid.

The ECU in this and other embodiments may also determine a relationship between the voltage strength level and an amount of change of output power for the ESS, and then calculate, based on the relationship and the voltage strength level, an amount of change of the output power for the ESS. In response to the grid event, the ECU may temporarily adjust the baseline system voltage strength level via implementation of the change of the output power, via the battery elements, when one or more of the corresponding voltages reaches the defined voltage limits.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 illustrates a representative energy storage system (ESS) having a controller configured in accordance with the disclosure.

FIG. 2 illustrates a portion of the example ESS of FIG. 1.

FIG. 2A is a schematic front view of another example ESS constructed in accordance with an aspect of the disclosure.

FIG. 2B is a schematic isometric view of still another example ESS constructed in accordance with another aspect of the disclosure.

FIG. 3 depicts a representative system for managing the ESS of FIGS. 1, 2, or 2A.

FIG. 4 is a flow chart describing a method for controlling the ESS of FIGS. 1, 2, or 2A based on a voltage derivative response as set forth herein.

FIG. 5 illustrates exemplary control logic for implementing the method of FIG. 4.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

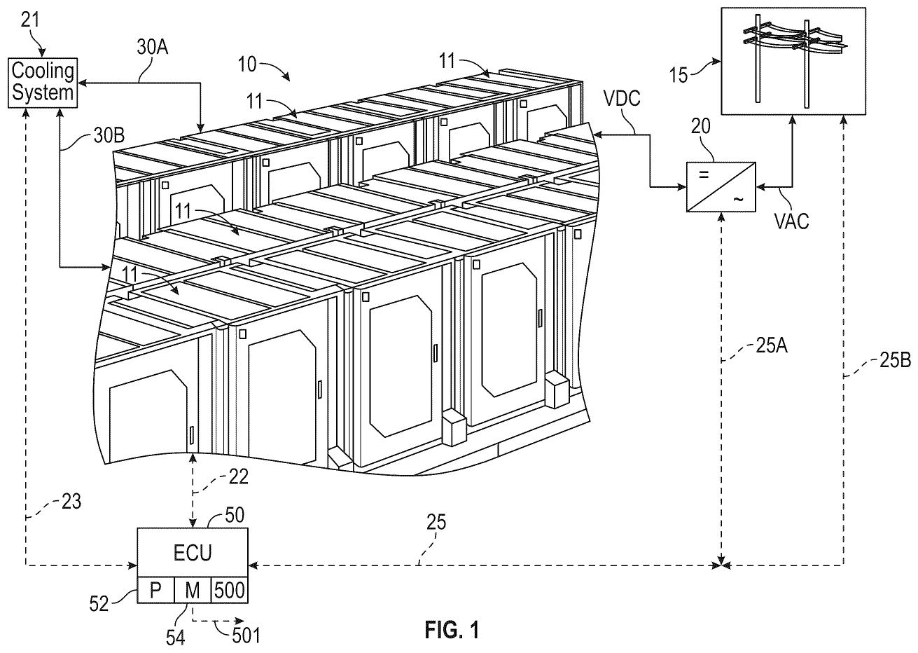

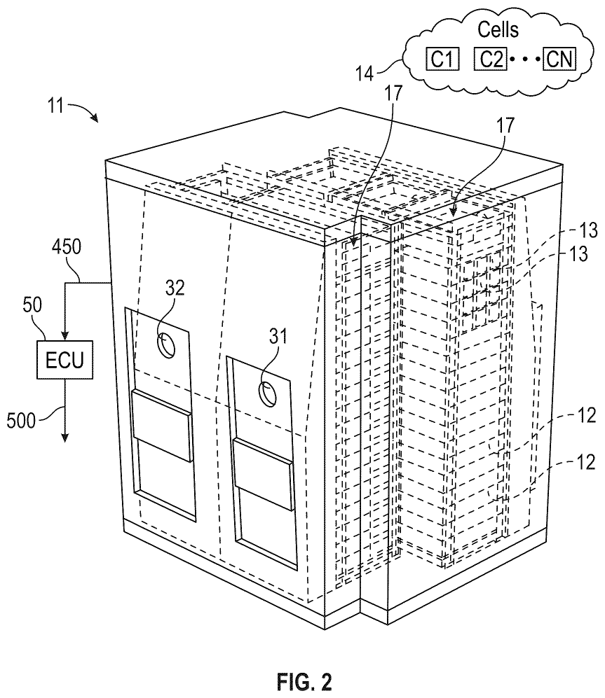

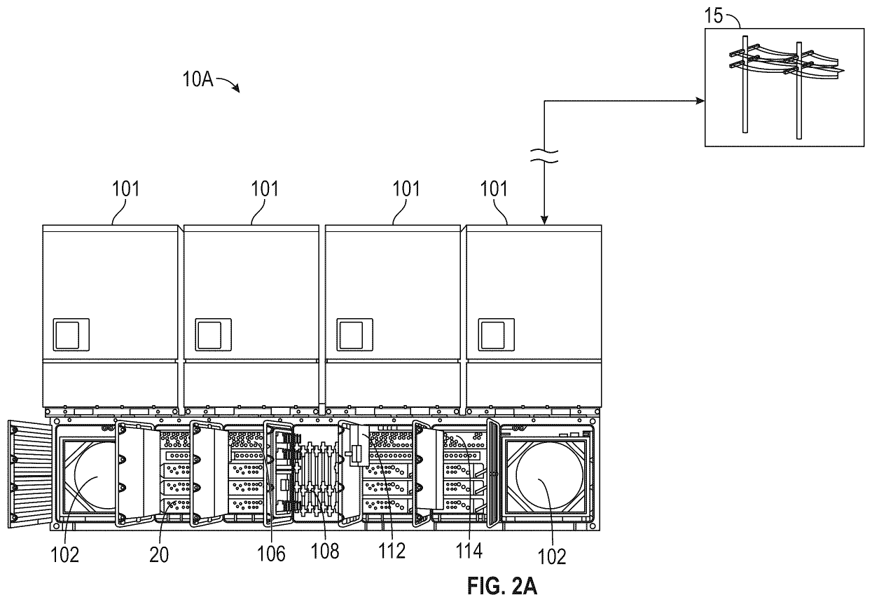

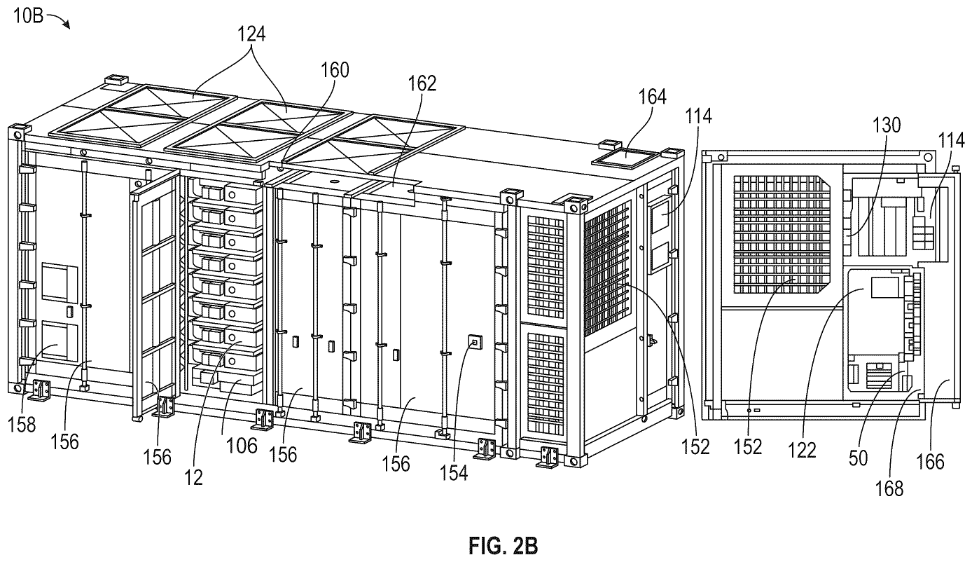

Referring to the drawings, wherein like reference numbers refer to the same or like components in the several Figures, FIG. 1 schematically illustrates an electronic control unit (ECU) 50 for use with an energy storage system (ESS) 10 having an application-suitable number of energy storage units 11. The ESS 10 of FIG. 1 is just one possible implementation, with alternative ESSs 10A and 10B described below with reference to FIGS. 2A and 2B, respectively.

Industry-wide, various grid events can lead to a sudden reduction or increase in grid voltage, i.e., a threshold voltage deviation. This in turn can cause grid-following devices such as the ESS 10 of FIG. 1 to momentarily block power or divert output to reactive support, thus causing performance issues upstream at the point of an external power source 15. Extreme voltage events can cause equipment damage. Voltage support modes tend to provide reactive power according to a setpoint, a power factor range, or a voltage range. However, only the latter can help mitigate grid-side voltage fluctuations.

A problem recognized herein is that conventional controls based on a proportional response to absolute voltage deviations will tend to command required reactive support, i.e., movement of power within the ESS 10 or its variants to produce magnetic and electric fields, store energy in transformers, etc., only after a voltage deviation threshold has been reached. This may occur too late for optimal effectiveness. To help address such a problem, the ECU 50 as described herein with reference to FIGS. 1-5 is configured to control output power of the ESS 10 to the external power source 15, e.g., a utility grid, in response to a rate of change of an alternating current (VAC) grid voltage from the external power source 15. This rate is noted herein as the rate of change of voltage (“RoCoV”). As set forth below, the ECU 50 is configured to temporarily adjust a baseline system voltage level needed by the external power source 15 by increasing reactive power within the ESS 10, e.g., by transmitting control signals to one or more control processors of the ESS 10 to thereby command the change in output power.

The representative ESS 10 of FIG. 1, and the ESSs 10A and 10B of FIGS. 2A and 2B, are configured for securing, containing, and supporting a collection of battery elements, e.g., battery modules/racks 12, battery submodules 13, and/or battery cells 14 shown in the simplified non-limiting embodiment of FIG. 2. As shown in FIG. 2, for instance, the battery racks 12 may each having one or more battery submodules 13, which collectively form one or more corresponding electrochemical battery packs 17. Each battery submodule 13 may include one or more series-connected or parallel-connected battery cells 14, e.g., a plurality of sealed lithium-ion cells or other high-energy energy storage cells such as lithium iron phosphate, silver-oxide, nickel-zinc, nickel metal hydride, lead-acid, nickel-cadmium, etc. For illustrative simplicity and clarity, the battery cells 14 are illustrated in FIG. 2 as nominal battery cells C1, C2, . . . , CN, with “N” being an application-specific integer value.

The representative ESS 10 illustrated in FIG. 1 includes the energy storage units 11, each respectively controlled by a local control processor (not shown) in communication with the ECU 50, e.g., by transmitting control signals to the local control processors or processor 52. A power conversion module (=/~) 20 in this non-limiting embodiment provides alternating current (AC) voltage (VAC) and a direct current voltage (VDC) as appreciated in the art, with the ESS 10 also including the ECU 50 and a cooling system 21. The cooling system 21 may be integral with or external to the ESS 10 in different embodiments.

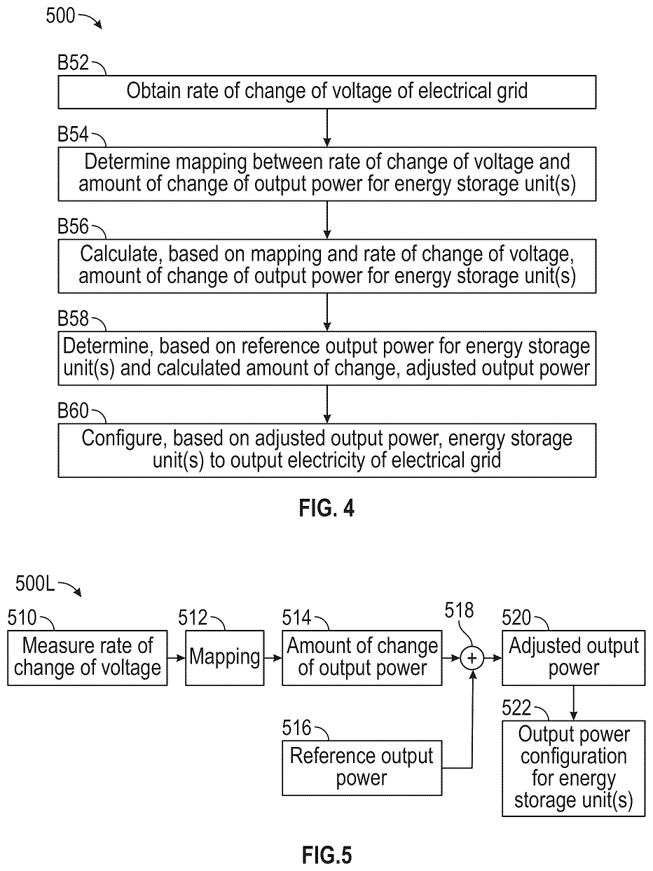

The ECU 50 of FIGS. 1 and 2 is operable for receiving input signals 22 from the ESS 10. The ECU 50 may also receive input signals 23 from the cooling system 21 and input signals 25A and 25B from the power conversion module 20 and the external power supply15, respectively, the latter two of which may combine as input signals 25. The ECU 50 is also operable for generating output signals 501 in response to performance of a method 500, a representative embodiment of which is illustrated in FIG. 4 and described below. While the ECU 50 described below may be used with ESSs of other constructions, the ESS 10 of FIG. 1 is representative of a grid-scale, industrial strength energy storage infrastructure location/power plant, e.g., the commercially available Gridstack™.

The ESS 10 of FIG. 1 may receive AC power from the external power supply in the non-limiting example embodiment of FIG. 1 when consumer demand for such power is lower than the existing/non-supplemented capacity of the external power supply 15. Conversely, the ESS 10 may offload stored electrical power to the external power supply 15 via the power conversion module 20 when demand exceeds the capacity of the external power supply 15.

In the example embodiment of FIG. 1, the power conversion module 20 remains central to power flow between the ESS 10 and the external power supply 15. Other embodiments may direct DC electrical power to the ESS 10, e.g., from solar panels or other DC power generation systems, in which case the ESS 10 may include a DC-DC converter and suitable filtering components (not shown) for regulating the level of DC power flow between the ESS 10 and the external power supply 15.

With respect to the cooling system 21, this component is coupled to the energy storage units 11 and the ECU 50 and configured to provide an application-suitable electrical coolant 30A, 30B to the ESS 10 at a relatively low first temperature. As shown in FIG. 2 for one energy storage unit 11, such coolant may be circulated through one or more inlet ports 31. The ESS 10 may also discharge coolant back to the cooling system 21 of FIG. 1 at a relatively high second temperature from at least one outlet port 32 of FIG. 2. A representative embodiment of the cooling system 21 may include a heat exchanging system having a pump, a condenser, a heat exchange, and a sump, none of which are shown but all of which are well understood by those of ordinary skill in the art.

The ECU 50 of FIGS. 1 and 2, e.g., a computer device or devices having requisite amounts and types of transitory and non-transitory memory, one or more processors, input/output circuity, etc., is in wired or wireless networked communication with the ESS 10, along with its plurality of energy storage units 11. The ECU 50 is also in communication with the power conversion module 20, the cooling system 21, and the external power source 15.

Referring briefly to FIG. 2A, a schematic front view of an example energy storage system (ESS) 10A having a plurality of modular pods 101 is shown in accordance with an aspect of the disclosure. The ESS 10A may include two cooling systems 102, the power conversion module 20, a direct current protection module (DCPM) 106, auxiliary components 114, an HVAC system 114, plumbing 108, and a fire panel 112. As with the FIG. 1 embodiment, the energy storage system 10A may be coupled with the external power source 15.

In another embodiment as shown in FIG. 2B, a schematic isometric view of an ESS 10B is shown in accordance with one aspect of the disclosure. The ESS 10B generally includes the ECU 50, a DCPM 106, an HVAC system 114, a DC disconnect switch 122, deflagration panels 124, an uninterruptible power supply (UPS) 130, battery modules 12, a chiller compartment 152, a fast stop (F-stop) 154, an enclosure door 156, an inlet louver 158, multi detectors 160, a hydrogen (H₂) gas detector 162, a vent panel 164, an enclosure side door 166, and a battery cooling plate door 168, with other possible components as shown in FIG. 2A possibly present but hidden from view. These and other possible constructions for implementing the ESS 10 of FIG. 1 are disclosed in U.S. patent application Ser. No. 19/359,105 , filed on 15 Oct. 2025, which is hereby incorporated by reference in its entirety.

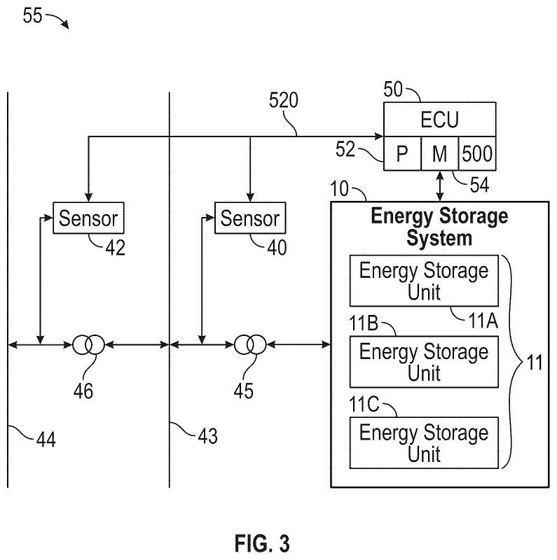

Referring now to FIG. 3, a control system 55 for use with the ESS 10 of FIG. 1 is shown schematically for illustrative simplicity and clarity. The ECU 50 may operate as part of the control system 55 and include components and circuitry in the form of various combinations of Application Specific Integrated Circuit(s) (ASIC), Field-Programmable Gate Array (FPGA), electronic circuit(s), central processing unit(s), for example one or more microprocessor(s) and associated memory component(s). In one or more embodiments, the control system 55 may include or be in communication with sensors 40 and 42, one or more control processors (P) 52, and non-transitory computer readable storage medium (“memory”) (M) 54. The sensors 40, 42 are operable for sensing electrical parameters of the ESS 10 of FIG. 1 and reporting the same to the processor 52 as electrical data 520. The electrical data 520 may include measured/sensed voltages of the battery modules 12, the battery submodules 13, and/or battery cells 14 (FIG. 2), or larger or smaller strings/groups of such battery cells 14 in different implementations.

The representative control system 55 of FIG. 3 may include the ESS 10 having one or more energy storage units 11, e.g., energy storage units 11A, 11B, and 11C as shown for simplicity. The control system 55 may include one or more power lines 43 and 44, one or more transformers 45 and 46, and the sensors 40 and 42. As appreciated in the art, a transformer such as the representative transformers 45 and 46 may be used to change voltage levels of an applied AC voltage. The various components or devices of the control system 55 may be connected with each other via a network (e.g., using interconnected communication links).

The network may include one or more of any of various types of networks for communication of information, such as a cellular network (e.g., 2G, 3G, 4G, or 5G), a satellite network, a Wi-Fi network, a WiMAX network, a Bluetooth network, a near-field communication (NFC) network, a low-power wide-area networking (LPWAN) network, a mobile network, a terrestrial microwave network, a wireless ad hoc network, an Ethernet network, a telephone network, a power-line communication (PLC) network, a coaxial cable network, an optical fiber network, and/or the like. The network may include a wired network or a wireless network. The network may include a personal area network, a local area network, a metropolitan area network, a wide area network, a global area network, a space network, or any other type of computer network that may use data connections between network communication nodes. In some examples, the network may include an Internet Protocol (IP) based network.

The power lines 43, 44 of FIG. 3 may be associated with the external power source 15 of FIG. 1. The ESS 10 may receive energy via the power lines 43, 44 and store the received energy, and/or may output energy to the power lines 43, 44. For example, the ESS 10 may include a grid energy storage within an electrical power grid (e.g., an energy storage that may be configured to store electrical energy when electricity is plentiful in an electrical power grid and may be configured to output electrical energy to the electrical power grid when demand for electricity is high). The ESS 10 may store electrical energy when demand for electricity is low and may output electrical energy to the grid when demand for electricity is high.

In some examples, the power lines 43, 44 may be associated with (e.g., may be connected to, or may include) bus bars of differing levels of voltage. For example, the bus bars may function as points of connection between power lines, transformers, sensors (e.g., 40, 42), and/or other suitable components. In addition to sensing voltage from the external power source 15 as described below, the sensors 40, 42 may measure one or more other parameters associated with the control system 55. For example, the sensors 40, 42 may include current sensors, voltage sensors, power sensors for measuring active or reactive power, or other types of sensors for obtaining measurements associated with the control system 55 and the ESS 10.

Still referring to FIG. 3, the processor 52 of the ECU 50 may execute previously recorded instructions/a computer program to perform any of the functions of the method 500 described herein. The processor 52 may include, for example, integrated circuits, microchips, microcontrollers, microprocessors, central processing units (CPUs), graphics processing units (GPUs), digital signal processors (DSPs), field programmable gate arrays (FPGAs), or other units suitable for executing instructions or performing logic operations. The control processor 52 may include a single-core or multiple-core processor (e.g., dual-core, quad-core, or with any desired number of cores). The processor 52 may provide the ability to execute, control, run, or store multiple processes, applications, or programs. In some examples, the processor 52 may be configured to provide parallel processing functionalities to allow a device associated with the processor to execute multiple processes simultaneously. In some examples, the processor 52 may be configured with virtualization technologies. Other types of processor arrangements may be implemented to provide the capabilities described herein.

The memory 54 may include a non-transitory computer-readable medium that may store instructions that, when executed by at least one processor, cause the at least one processor 52 to perform one or more processes as described herein. A non-transitory computer-readable storage medium may include any type of physical memory on which information or data readable by at least one processor may be stored. A non-transitory computer storage medium may include read-only memory (ROM), compact disc read-only memory (CD-ROM), digital versatile discs (DVDs), programmable read-only memory (PROM), erasable programmable read-only memory (EPROM), non-volatile random-access memory (NVRAM), volatile memory, non-volatile memory, hard drives, flash drives, disks, caches, registers, an optical data storage medium, a physical medium with patterns, or networked versions thereof. A non-transitory computer-readable medium may include multiple structures and may be located at a local location or at a remote location, with transitory or volatile memory also being used as needed by the ECU 50 as part of the memory 54.

Referring now to FIG. 4, the method 500 noted above is described in terms of discrete code segments or logic blocks for illustrative simplicity. Each logic block is executable by the ECU 50 and its resident processor(s) 52 to perform the described calculations in the overall control of the ESS 10 of FIG. 1. Exemplary logic circuit 500L of FIG. 5 includes corresponding blocks describing data flow within the ECU 50.

In general, performance of the method 500 enables control of the ESS 10 and its plurality of DC energy storage devices, e.g., batteries. The method 500 may include determining a voltage strength level of the external power source 15, with the voltage strength level being a maximum power surge of the external power source that would not cause the ESS 10 to exceed defined voltage limits. The method 500 may include determining a baseline system voltage strength level required by the external power source 15 during steady-state operation thereof, and controlling an output state of the energy storage units 11 of FIG. 1 to collectively meet the baseline system voltage strength level.

Aspects of the method 500 may include sensing corresponding voltages for each respective one of the battery elements, e.g., the battery cells 14 of FIG. 2, and sensing or detecting a grid event of the external power source 15. This action entails obtaining the above-noted rate of change of voltage (RoCoV) of the external power source 15. From the RoCoV, the system dispatches reactive power, i.e., kVAR, with the entire function being the voltage derivative response (VdR). In response to the detected grid event, the method 500 includes temporarily adjusting the baseline system voltage strength level or reactive power, e.g., by decreasing or increasing the voltage stiffness as needed, via control of the battery elements. This occurs when one or more of the corresponding voltages reaches the defined voltage limits.

An exemplary embodiment of the method 500 is shown in FIG. 4. Beginning with block B52, the ECU 50 obtains the rate of change of voltage (RoCoV) of the external power source 15 of FIG. 1. Performance of block B52 may include receiving measurements of the voltage level of the external power source 15, e.g., at an input element of the ESS 10 or reported to the ECU 50 by the external power source 15, and calculating the RoCoV via the ECU 50. This may occur based on periodic voltage measurements from one of more sensors coupled to the external power source 15/electrical grid.

Such measurements may be taken over a calibrated fixed or sliding time interval, such as 1 millisecond (ms) to 500 ms or more, in different implementations. Calculation of the RoCoV may be performed by determining a ratio of change in magnitude of two voltage measurements to a time length between the measurements. For example, a difference in a representative first voltage measurement of 1000kV and a representative second voltage measurement of 800 kV, i.e., 200 kV, over a nominal time interval of 10 ms, would equate to 20 kv/ms. The method 500 proceeds to block B54 when the ECU 50 has ascertained the RoCoV.

Block B54 includes determining a mapping or relationship between the RoCoV from block B52, and an amount of change of output reactive power for the ESS 10 of FIG. 1, i.e., VdR. Block B54 may be achieved in various ways within the scope of the disclosure. For instance, block B54 may entail determining a correlation or relationship between the RoCoV from block B52 and an amount of change of output power for the ESS 10 of FIG. 1. Mapping may be based on a ratio applicable to a range of the RoCoV. The ECU 50 could multiply the RoCoV by the ratio if the RoCoV falls within the defined range. The range may have any desired values for its outer bounds and/or may be specified by an operator or administrator of the one or more energy storage units 11.

Mapping in accordance with block B54 may alternatively include using a piecewise linear function defining a relationship between the RoCoV and an amount of change of the output power for the ESS 10. These and other possible approaches to mapping rate of change data are disclosed in U.S. patent application Ser. No. 18/177,582 filed on Mar. 2, 2023 (now published as US Pub. No. 2024/0295861A1), which is hereby incorporated by reference in its entirety. The method 500 proceeds to block B56 after determining the mapping between the RoCoV and the amount of change in output power from the ESS 10.

At block B56, the ECU 50 may calculate, based on the mapping and the RoCoV as explained above, an amount of change of the output power for the ESS 10. Block B56 may include determining an adjusted output power based on a reference output power for the ESS 10 and the calculated RoCoV. The reference output power for its part may include, for example, a baseline level of output power of the ESS 10 designated for normal/steady-state operating scenarios of the external power source 15 of FIG. 1, absent voltage spikes or dips. The adjusted reactive output power in one or more implementations may correspond to a sum of the reference output power and the calculated amount of change of the output power for the ESS 10.

In some embodiments, the mapping may cause the ESS 10 to decrease its output power relative to the reference output power when the RoCoV indicates an increase in voltage, i.e., a source spike, or to increase output power relative to the reference output power when the RoCoV indicates a voltage sag of the external power source 15. The adjusted output power may be larger than the reference output power, as the calculated amount of change of the output power may be summed with the reference output power to determine the adjusted output power. Adjusting the output power of the ESS 10 may help slow, or reduce the magnitude of, the voltage derivative response of the external power source 15, e.g., by contributing to balancing the supply and demand of electrical energy in the electrical grid.

At block B58, the ECU 50 of FIGS. 1-3 may determine an adjusted output power based on a reference output power for the ESS 10 and the calculated amount of change. The method 500 thereafter proceeds to block B60 to configured the ESS 10 to output electricity to the external power source 15 of FIG. 1.

Referring to the logic diagram 500L of FIG. 5, where logic blocks 510 and 512 correspond to blocks B52 and B54 of FIG. 4, the amount of change of the output power in logic block 514 (block B56 of FIG. 4) may be summed with the reference output power in logic block 516 at a summation node 518. The sum is the adjusted output power, which is temporarily stored in memory 54 of FIGS. 1 and 3 at logic block 520. Disclosed embodiments include configuring, based on the adjusted output power, the one or more energy storage units to output electricity to the electrical power grid. This occurs at logic block 522 of FIG. 5. For example, after determining the adjusted output power at logic block 520, the ECU 50 may configure, based on the adjusted output power, the ESS 10 to output electricity to the electrical at the level of the adjusted output power (logic block 520).

Within the scope of the disclosure, block 522 may configure the ESS 10 by instructing the control components for the ESS 10, e.g., the battery modules 12 or battery cells 14 of FIG. 2, to output or discharge power to the grid during a particular time at a particular rate. This may occur based on the level of the adjusted output power. Control may be established using appropriate techniques, such as but not limited to electrical circuits with switch controls, charge or discharge controllers, charge or discharge regulators, battery regulators, and the like, so that the ESS 10 may be controlled to be in a state of outputting electricity to the electrical grid at a particular rate.

Additionally (or alternatively), power conversion systems used to couple the ESS 10 to the external power source 15 of FIG. 1 may be controlled by the ECU 50 to adjust parameters of the power conversion module 20, e.g., to accommodate the changes to the output power levels of the batteries). In some examples, coordinated control of the batteries of the energy storage unit(s), the power conversion systems of the energy storage unit(s), and/or other components, elements, and/or devices associated with the energy storage unit(s) may be performed to adjust the output power of the energy storage unit(s). Adjusting the output power of the energy storage unit(s) coupled to the electrical power grid may help slow, or reduce the magnitude of, the rate of change of the voltage of the grid (e.g., by contributing to balancing the supply and demand of electrical energy in the grid).

Additionally (or alternatively), the processes associated with measuring the rate of change of the voltage and/or adjusting the output power of the energy storage unit(s) may be performed periodically or continuously. For example, after the configuring of the energy storage unit(s) based on the adjusted output power, the rate of change of the voltage may be measured and/or determined again, and the output power of the energy storage unit(s) may be adjusted based on the later measured and/or determined rate of change of the voltage (e.g., if an absolute value of the later measured and/or determined rate of change of the voltage is not below a threshold).

The present teachings may be adapted for use with electrical grids having high penetration of renewable, which can often see sudden and rapid changes in grid voltage. By providing voltage derivative response, a battery power plant such as the ESS 10 of FIG. 1 can begin providing reactive support well before an absolute voltage deviation has exceeded deadband and/or upper thresholds. Implementation of the method 500 reduces voltage stiffness issues with the external power source 15 by reducing the need for the ESS 10 to momentarily block power or divert output in the face of grid events. These and other attendant benefits will be readily appreciated by those of ordinary skill in the art in view of the foregoing disclosure.

The present disclosure may be embodied in many different forms. Representative examples are shown in the various drawings and described herein in detail as non-limiting examples of the disclosed principles. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

We claim:

1. A method for controlling an energy storage system (ESS) having a plurality of battery elements, the method comprising:
determining a voltage strength level of a power grid, the voltage strength level being a maximum power surge of the power grid that would not cause the ESS to exceed defined voltage limits;
determining a baseline system voltage strength level required by the power grid during steady-state operation thereof;
controlling an output state of the ESS to collectively meet the baseline system voltage strength level;
sensing corresponding voltages for each respective one of the battery elements;
detecting a grid event of the power grid, including obtaining a rate of change of voltage (“RoCoV”) of the power grid; and
in response to the grid event, temporarily adjusting the baseline system voltage strength level using the RoCoV, via control of the battery elements, when one or more of the corresponding voltages reaches the defined voltage limits.

2. The method of claim 1, wherein detecting the grid event includes sensing an RoCoV event of the power grid during a threshold high SoC of the ESS or a threshold low SoC of the ESS.

3. The method of claim 1, further comprising:
determining a relationship between the RoCoV and an amount of change of output power for the ESS; and
calculating as a calculated amount of change, based on the relationship and the RoCoV, an amount of change of the output power for the ESS.

4. The method of claim 3, wherein calculating the amount of change of the output power for the ESS includes combining a reference output power and the calculated amount of change.

5. The method of claim 3, wherein temporarily adjusting the baseline system voltage strength level includes transmitting control signals to one or more local control processors of the ESS to thereby command the change in output power.

6. The method of claim 1, wherein determining the voltage strength level of the power grid includes receiving voltage measurements from one or more sensors and calculating the voltage strength level using the voltage measurements.

7. The method of claim 1, wherein temporarily adjusting the baseline system voltage strength level includes increasing reactive power within the ESS.

8. An energy storage system (ESS) for use with a power grid, comprising:
a plurality of battery elements;
one or more sensors; and
an electronic control unit (ECU) in communication with the one or more sensors, wherein the ECU is configured to:
determine voltage strength level of the power grid, the voltage strength level being a maximum power surge of the power grid that would not cause the ESS to exceed defined voltage limits;
determine a baseline system voltage strength level required by the power grid during steady-state operation thereof;
control an output state of the battery elements to collectively meet the baseline system voltage strength level;
determine corresponding voltages for each respective one of the battery elements;
detect a grid event of the power grid, including obtaining a rate of change of voltage (“RoCoV”) of the power grid; and
in response to the grid event, temporarily adjust the baseline system voltage strength level via control of the battery elements when one or more of the corresponding voltages reaches the defined voltage limits.

9. The ESS of claim 8, wherein the plurality of battery elements includes a plurality of electrochemical battery cells.

10. The ESS of claim 9, wherein the one or more sensors include at least one voltage sensor operable for directly sensing the corresponding voltages as corresponding cell voltages of the electrochemical battery cells.

11. The ESS of claim 8, wherein the ECU is configured to determine the grid event as an RoCoV of the power grid during a threshold high SoC of the ESS or a threshold low SoC of the ESS.

12. The ESS of claim 8, wherein the ECU is configured to:
determine a relationship between the voltage strength level and an amount of change of output power for the ESS; and
calculate, based on the relationship and the voltage strength level, an amount of change of the output power for the ESS.

13. The ESS of claim 12, wherein the ECU is configured to calculate the amount of change of the output power for the ESS by combining a reference output power and the calculated amount of change of the output power for the ESS.

14. The ESS of claim 12, wherein the ECU is configured to temporarily adjust the baseline system voltage strength level by transmitting control signals to one or more control processors of the ESS to thereby command the amount of change of the output power for the ESS.

15. The ESS of claim 11, wherein the ECU is configured to obtain the voltage strength level of the power grid by receiving voltage measurements from one or more sensors and calculating the voltage strength level using the voltage measurements.

16. The ESS of claim 11, wherein the ECU is configured to temporarily adjust the baseline system voltage strength level by increasing reactive power within the ESS.

17. An electronic control unit (ECU) for an energy storage system (ESS) for use with a power grid, comprising:
a processor; and
a computer storage medium (“memory”) on which is recorded instructions, the instructions being executable by the processor to cause the ECU to:
determine a voltage strength level of a power grid, the voltage strength level being a maximum power surge of the power grid that would not cause the ESS to exceed defined voltage limits;
determine a baseline system voltage strength level required by the power grid during steady-state operation thereof;
control an output state of a plurality of battery elements of the ESS to collectively meet the baseline system voltage strength level;
sense corresponding voltages for each respective one of the battery elements;
detect a grid event of the power grid, including obtaining a rate of change of voltage (“RoCoV”) of the power grid;
determine a relationship between the voltage strength level and an amount of change of output power for the ESS;
calculate, based on the relationship and the voltage strength level, an amount of change of the output power for the ESS; and
in response to the grid event, temporarily adjust the baseline system voltage strength level via implementation of the change of the output power, via the battery elements, when one or more of the corresponding voltages reaches the defined voltage limits.

18. The ECU of claim 17, wherein the plurality of battery elements are controlled via one or more local control processors of the ESS, the instructions being executable by the processor to cause the ECU to:
transmit control signals to the one or more local control processors of the ESS to thereby command the change in output power.

19. The ECU of claim 17, the instructions being executable by the processor to cause the ECU to:
obtain the voltage strength level of the power grid by receiving voltage measurements from one or more sensors, and calculating the voltage strength level using the voltage measurements.

20. The ECU of claim 17, the instructions being executable by the processor to cause the ECU to:
temporarily adjust the baseline system voltage strength level by increasing reactive power within the ESS.
